(19) United States
(12) Patent Application Publication
(10) Pub. No.: US 2014/0027502 A1
(43) Pub. Date: Jan. 30, 2014

(54) NON-TRANSPARENT DISPOSABLE CUP WITH MEASUREMENT MARKINGS AND METHOD FOR MAKING THE SAME

(71) Applicant: Jeffrey D. Schwartz, Winnetka, IL (US)

(72) Inventor: Jeffrey D. Schwartz, Winnetka, IL (US)

(21) Appl. No.: 13/559,785

(22) Filed: Jul. 27, 2012

(51) Int. Cl. B65D 3/28; B31B 1/88

(52) U.S. Cl. 229/400; 493/55

(57) ABSTRACT

A transparent disposable coffee cup used for dispensing coffee by coffeehouses and the like is disclosed. Measurement markings are formed on an interior surface of the cup adjacent the mouth. The measurement markings are identify different fill lines which relate to the amount of milk or cream that the consumer wishes to add to the coffee. Depending on the cup size two or more additional raised markings are provided. These marking are located below the top fill line and may optionally represent the space to add a certain percentage of cream. For 12 ounce cups, the markings may be located at levels equivalent to one ounce of cream and two ounces of cream. In accordance with an important aspect of the invention, the raised markings can be made on an interior surface of the cup by automated manufacturing methods.

### BACKGROUND OF THE INVENTION

1. Field of the Invention

The present invention relates to a cup and more particularly to a disposable non-transparent cup, such as a coffee cup, that includes measurement markings which can be made using automated manufacturing processes.

2. Description of the Prior Art.

Disposable cups, such as coffee cups, are well known in the art. Such disposable coffee cups are normally made from materials, such as, styrofoam. Disposable coffee cups are also known to be made from paper and more specifically 100% bleached virgin paperboard. The paperboard is bleached with various chemicals to remove natural pigments in the paperboard. In order to prevent the coffee cups from leaking, the paperboard is known to be coated with a plastic material, such as polyethylene. Polyethylene is a synthetic resin that makes the paper watertight and thus suitable for use as a coffee cup.

Coffee cups made from bleached paperboard and coated with a plastic material are commonly used at stores operated by coffeehouse chains, such as Starbucks Corporation. Such coffee cups are non-transparent. As such, the coffee cups have no measurement indications on the cup to enable store employees to gauge how much coffee to fill in the cup.

Consumers that purchase their coffee from such coffeehouse chains are typically selective regarding the amount of cream or milk to be added to their coffee. Normally, the coffee is normally served to the consumer black. A cream and sugar bar is provided in the stores to enable consumers to add milk or cream and sugar to taste.

Adding cream or milk to the coffee can cause overfilling of the coffee cup which can cause a safety problem. Normally, when the consumer does not request the employee to “leave room” for cream or milk, the coffee cup is filled by the store employee to be fairly close to the top of cup. In order to avoid overfilling the cup, consumers are known to pour a portion of the coffee in a receptacle in order to allow milk or cream to be added. Such practice results in a significant amount of coffee being wasted.

Alternatively, consumers can request the store employee to “leave room” for cream or milk. Unfortunately with no markings in or on the cup, the store employee can only guess at how much coffee to put in the cup. In situations where too much room is left, the consumers normally hand the cup back to the store employee and request additional coffee. In situations in which the employee does not leave enough room, the consumer spills out the additional coffee in a receptacle.

Thus, there is a need for non-transparent cups, such as coffee cups, that include measurement markings so that the amount of room left for cream or milk can be specified by the consumer to avoid waste.

### SUMMARY OF THE INVENTION

Briefly, the present relates to a non-transparent disposable cup, such as a coffee cup, used for dispensing coffee by coffeehouses and the like. Measurement markings are provided adjacent the mouth of the cup. The measurement markings identify different fill lines which relate to the amount of milk or cream (hereinafter referred to as “cream”) that the consumer wishes to add to the coffee. For example, a marking closest to the mouth of the cup, i.e. top fill line, may optionally be used to represent a top fill line for both the coffee and the cream. Markings below the top fill line may be used to represent alternate fill lines as a function of the amount of cream to be added. Depending on the cup size, two or more additional markings may be provided. These marking are located below the top fill line and may optionally represent the space to add a certain percentage of cream. For 12 ounce cups, the markings may be located at levels equivalent to one ounce of cream and two ounces of cream. Thus, when a consumer orders coffee, the consumer may specify to the store employee to “leave room” for one cream or two creams. In this way, the amount of coffee wasted is minimized. In accordance with an important aspect of the invention, the markings can be made on an interior surface of the cup by automated manufacturing methods.

### DESCRIPTION OF THE DRAWING

These and other advantages of the present invention will be readily understood with reference to the following specification and attached drawing wherein:

FIG. 1A is a sectional view of one embodiment of the non-transparent disposable cup in accordance with the present invention illustrating spaced apart annular grooves formed on an interior surface of the non-transparent cup adjacent the mouth.

FIG. 1B is a sectional view of an alternate embodiment of a non-transparent disposable cup in accordance with the present invention illustrating spaced apart stepped annular grooves formed on an interior surface of the non-transparent cup adjacent the mouth.

FIG. 1C is a sectional view of a known non-transparent disposable cup.

FIG. 2A is an isometric view of the disposable cup illustrated in FIG. 1A, shown partially in section with a portion of the cup removed.

FIG. 2B is an isometric view of the disposable cup illustrated in FIG. 1B, shown partially in section with a portion of the cup removed.

FIG. 2C is an isometric view of the disposable cup illustrated in FIG. 1C, shown partially in section with a portion of the cup removed.

FIG. 3A is an exemplary block diagram illustrating the manufacturing steps for making a disposable cup illustrated in FIG. 2A.

FIG. 3B is a block diagram illustrating the manufacturing steps for making a disposable cup illustrated in FIG. 2B.

FIG. 3C is a block diagram illustrating the manufacturing steps for making a disposable cup illustrated in FIG. 2C.

FIG. 4A is an enlarged sectional view of the disposal cup illustrated in FIG. 2A disposed on a grooved mandrel.

FIG. 4B is an enlarged sectional view of the disposal cup illustrated in FIG. 2B disposed on a stepped mandrel.

FIG. 4C is an enlarged sectional view of the disposal cup illustrated in FIG. 2C disposed on a conventional mandrel.

FIG. 5 is an enlarged partial sectional view of the disposable cup illustrated in FIG. 2B and a stepped mandrel.

### DETAILED DESCRIPTION

The present invention relates to the use of measurement markings on a non-transparent disposable, such as a coffee cup used for dispensing coffee by coffeehouses and the like. Although a coffee cup is illustrated and described herein, the principles of the present invention are applicable to virtually any non-transparent disposable cup, such as a cup used for delivering medicine.

There are several embodiments of the invention. In two of the embodiments of the invention, raised measurement markings are formed on an interior surface and corresponding recessed markings are formed on an exterior surface of the cup adjacent the mouth. In a third embodiment of the invention, the measurement markings are simply printed on an interior surface of the cup. In the third embodiment, optional corresponding fill lines may be printed on an exterior surface of the cup.

The measurement markings are used to identify different fill lines for the coffee depending on the amount of cream that the consumer wishes to add to the coffee. For example, a marking closest to the mouth of the cup, i.e. top fill line, may optionally be used to represent a top fill line for both the coffee and the cream. Markings below the top fill line may be used to represent alternate fill lines as a function of the amount of cream to be added. Depending on the cup size two or more additional raised markings are provided. These marking are located below the top fill line and may optionally represent the space required to add a certain percentage of cream. For 12 ounce cups, the markings may be located at levels equivalent to one ounce of cream and two ounces of cream. Thus, when a consumer orders coffee, the consumer may specify to the store employee to “leave room” for one cream or two creams. In this way, the amount of coffee wasted is minimized. In accordance with an important aspect of the invention, the raised markings can be made on an interior surface of the cup by automated manufacturing methods.

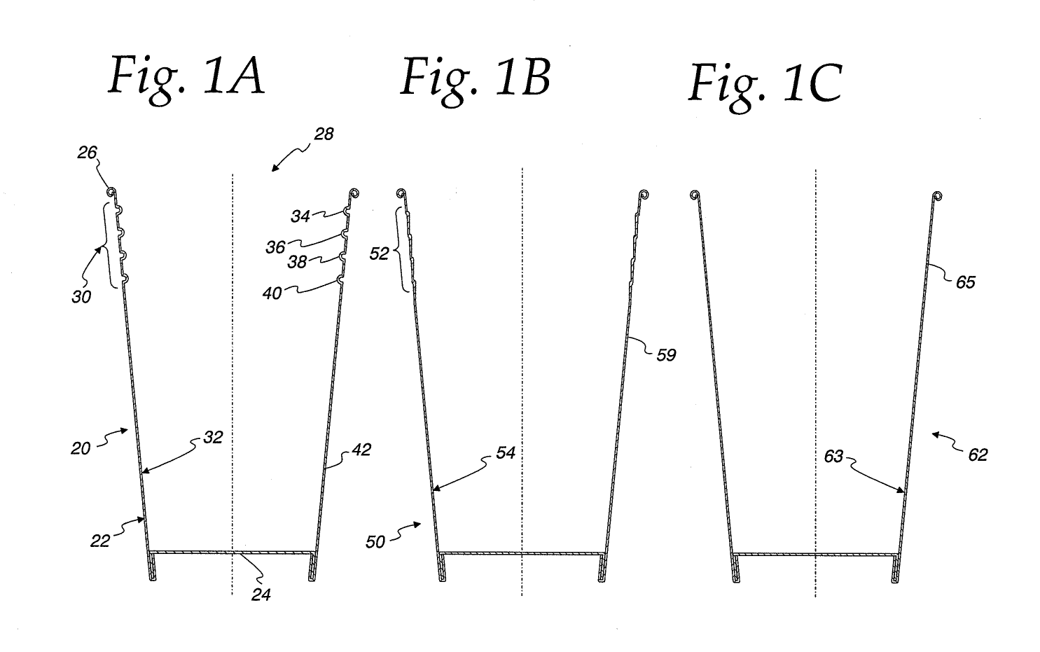

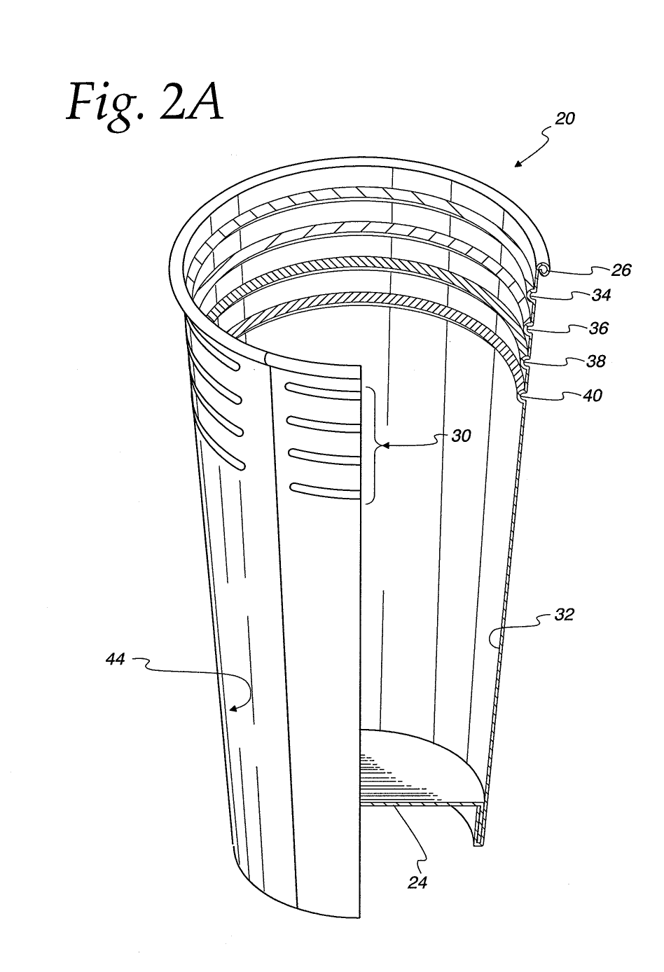

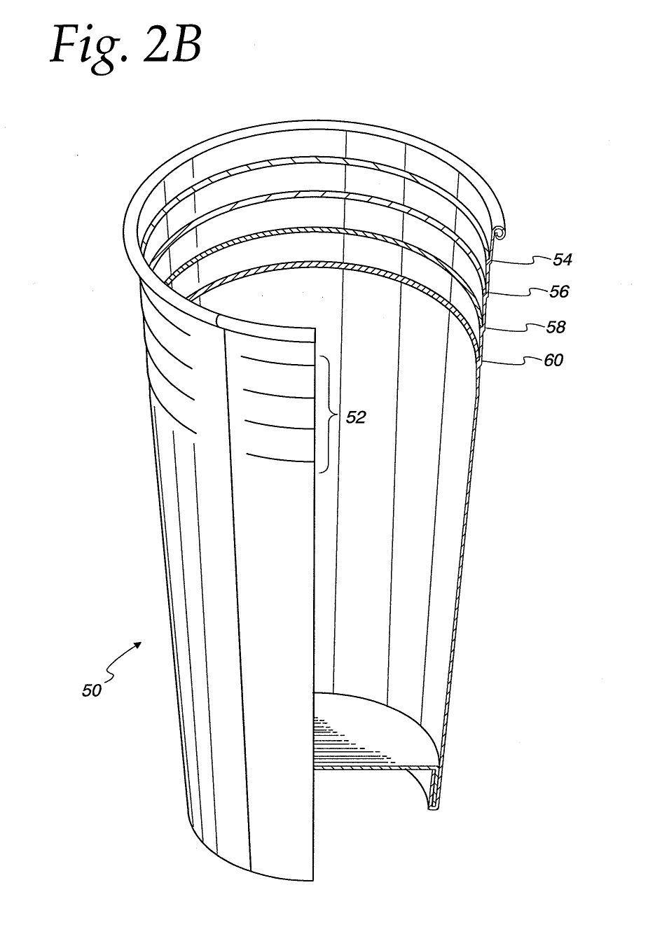

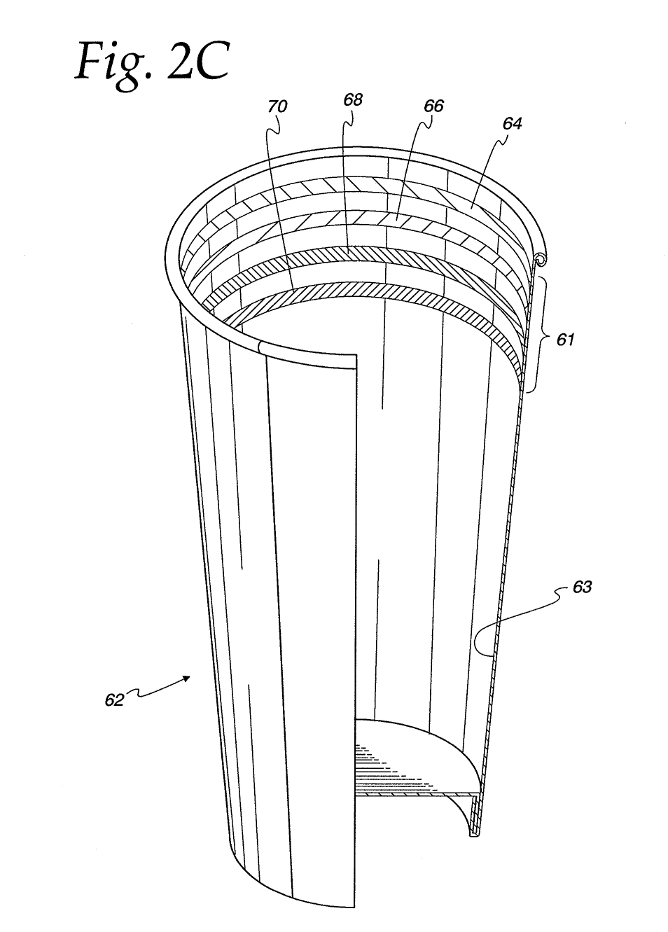

FIGS. 1A and 2A illustrate a first embodiment of the invention in which raised markings in the form of semi-circular grooves are formed on an inside surface of the cup and corresponding recessed markings are formed on an exterior surface of the cup. FIGS. 1B and 2B illustrate a second embodiment of the invention in which raised markings in the form of stepped grooves are formed on an inside surface of the cup and corresponding recessed markings are formed on an exterior surface of the cup. FIGS. 1C and 2C illustrate an embodiment in which measurement markings are simply printed on the inside of a disposable paper cup in which corresponding markings may optionally be printed on an exterior surface of the cup.

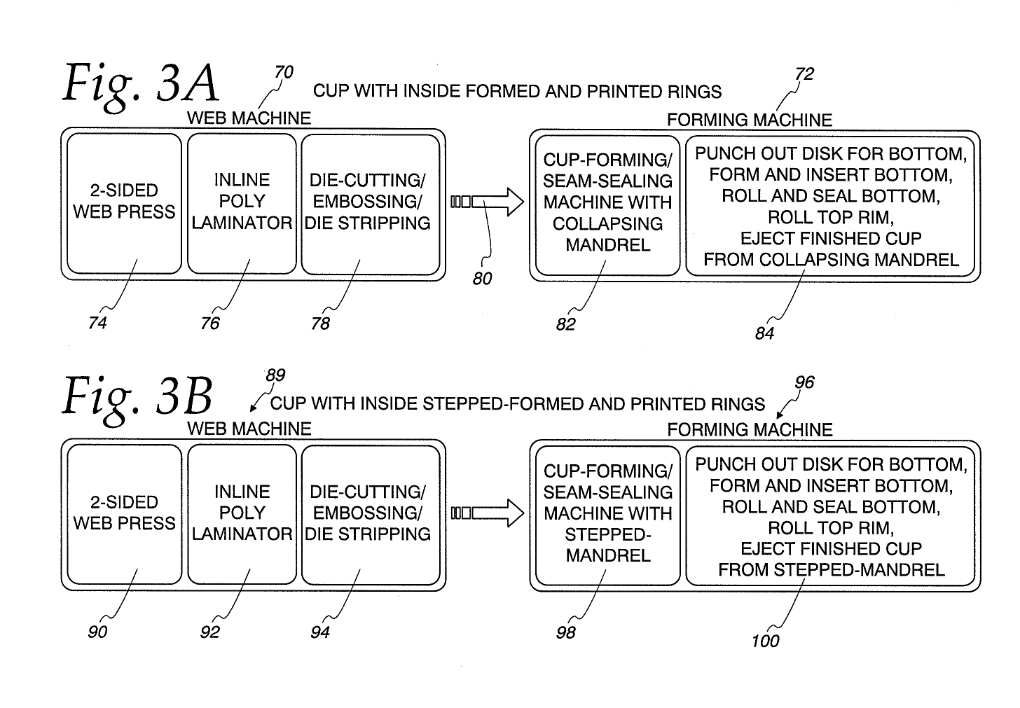

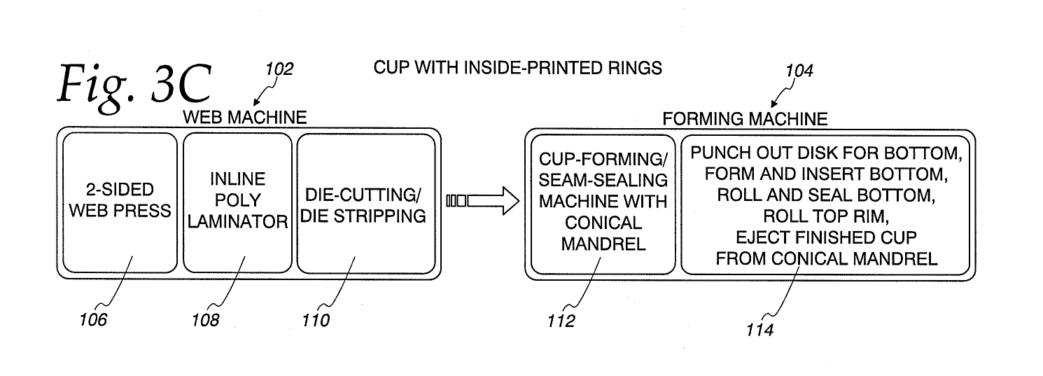

As mentioned above, an important aspect of the invention is that the coffee cups in accordance with the present invention which include the measurement markings can be manufactured using automated manufacturing processes. The manufacturing processes are illustrated in FIGS. 3A-5 and described below.

As illustrated and described herein, annular rings are shown for the measurement markings. However, other annular markings which do not circumscribe the inner perimeter surface of the cup are contemplated. For example, various other markings, such as, short arcuate segments, are also contemplated.

Referring first to FIGS. 1A and 2A, a first embodiment of the invention is illustrated and generally identified with the reference numeral 20. In this embodiment, the cup 20 includes an annular sidewall 22, a raised sealed bottom floor 24 and a roll top rim 26. Adjacent the mouth 28 of the cup 20 are measurement markings, generally identified with the reference numeral 30.

As shown, the measurement markings 30 circumscribe at least a portion of the inner perimeter surface 32 of the cup 20 and are formed, as shown, with a generally semicircular cross-sectional shape. However, as mentioned above, other measurement markings are also contemplated which have other shapes, for example, short line segments.

Four measurement markings 30 identified with the reference numerals 34-40 are shown in FIGS. 1A and 2A. More or fewer measurement markings are contemplated. The top measurement marking 34 may optionally be used as a top fill line marking the top level for coffee and cream. The measurement markings 36, 38 and 40 may be used to mark various volumetric increments. For example, for 12 ounce coffee cups, the measurement marking 36 may be used to indicate a level one ounce from the maximum fill line. In other words, assuming the top measurement marking 34 represents the 12 ounce level for a 12 ounce cup, the measurement marking 36 may be used to indicate an 11 ounce level to allow for one ounce of cream to be added. Similarly, the measurement markings 38 and 40 may be used to indicate 10 and 9 ounce levels, respectively. Other levels for the markings 36-40 are also contemplated.

As shown best in FIG. 2A, the measurement markings 34-40 are raised relative to an interior surface 32 of the cup 20. Corresponding measurement markings are also formed on an exterior surface 22 of the cup 20. As will be discussed in more detail below, the method for creating the raised markings 34-40 on the interior surface 32 of the cup provides an added benefit of providing recessed markings 30 on an exterior surface 42 of the cup 20 in the same operation. Thus, the measurement markings 30 are viewable on both the inside and outside of the cup 20. As such, the recessed markings 30 on the outside surface 44 of the cup 20 allow the store employee to illustrate to a customer the different levels of coffee filling. In addition, the raised measurement markings 34-40 on the interior surface 32 of the cup may optionally be printed with one or more different colors, as represented by the different cross section lines.

Various levels for the measurement markings are contemplated. In addition, the space above the coffee level, i.e. “room”, may be adjusted as a function of the cup size. For example, in addition to 12 ounce coffee cups, coffee houses are known to provide 16 ounce, 20 ounce and 24 ounce coffee cups. In order to provide measurement markings having the same proportion of cream, the distance measurement markings can easily be scaled and spaced so that there is the equivalent 1.5 ounces of space, for example, between each measurement marking for 16 ounce cups and the equivalent of 2.0 ounces of space, for example, for 24 ounce cups.

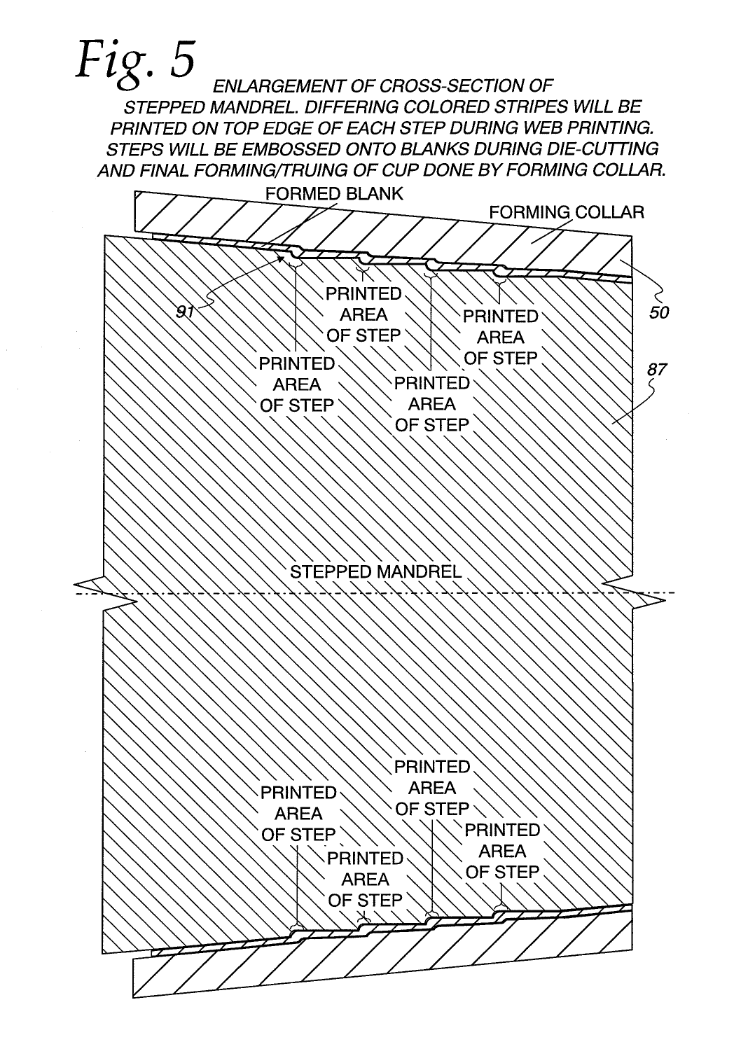

An alternate embodiment of the invention is illustrated in FIGS. 1B and 2B. In this embodiment, a cup 50 includes a plurality of measurement markings 52, formed as stepped recesses on an inner surface 54 of the cup 50. The cup 50 is similar in all other aspects to the cup 20 illustrated in FIGS. 1A and 2A. As will be discussed in more detail below and as best shown in FIG. 5, the stepped recesses 52 facilitate the manufacturing process.

Referring to FIG. 2B, four measurement markings 30 are shown, identified with the reference numerals 54-60. More or fewer measurement markings are contemplated. Similar to the embodiment illustrated in FIGS. 1A and 2A, the top measurement marking 54 may optionally be used as a top fill line marking the top level for coffee and cream. The measurement markings 56, 58 and 60 may be used to mark various volumetric increments, as discussed above.

Similar to the embodiment discussed above, the method for creating the raised markings 54-60 provides an added benefit of providing recessed markings on an exterior surface 59 of the cup 50 in the same operation. Thus, the measurement markings 52 are viewable on both the inside and outside of the cup 50, as discussed above. In addition, the inner measurement markings 54-60 may optionally be printed with different colors as represented by the different cross section lines.

Another alternate embodiment is illustrated in FIGS. 1C and 2C. In this embodiment, the measurement markings 61 may only provided on an interior surface 63 of a cup 62. Optionally, corresponding measurement markings (not shown) may also be provided on an exterior surface 65 of the cup 62. In all other respects, the cup 62 is similar to the cups 20 and 50. As shown in FIG. 2C, four measurement markings 68-70 are shown. These measurement markings 61 may be represented by different colors as indicated by the various cross sections.

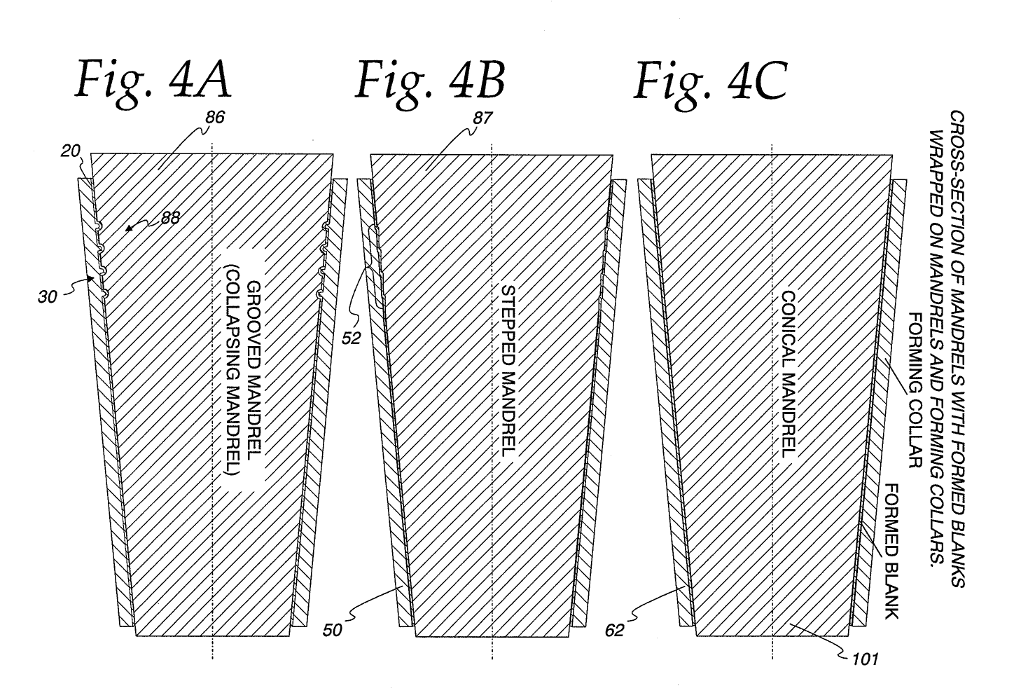

The cups 20, 50 and 62 can be manufactured using standard manufacturing processes as noted below. Block diagrams illustrating the processes for manufacturing the cups 20, 50 and 62 are illustrated in FIGS. 3A, 3B and 3C, respectively. The processes are similar except for the configuration of the mandrels used to form the basic cup shape from a blank. The various mandrel configurations for the cups 20, 50 and 62 are illustrated in FIGS. 4A, 4B and 4C, respectively and are discussed below. FIG. 5 illustrates enlarged cross section of the cup 50 and its associated mandrel.

With reference to FIGS. 3A, 3B and 3C, in general, paper cups, such as, coffee cups, are known to be manufactured by a conventional web machine and a conventional forming machine. As will be discussed in more detail below, the coffee cups 20, 50 and 62 can be manufactured using a conventional web machine and a conventional forming machine with variations of the configuration of the mandrel and forming collar used in the forming machine 72. The web machine forms the paper “flats” or blanks for the cups while the forming machine forms the flat or blank into a cup.

Referring to FIG. 3A, the cup 20 is typically formed from 170-350 g/m² paperboard. The paperboard is fed into a web machine 70 which includes a 2 sided web press 74. The web press 74 unrolls the paper and prints the desired pattern on one or both sides of the paperboard. One or more optional colors may be printed one at a time. In accordance with the present invention, measurement markings are scored at desired measurement points, for example, 1 ounce, 2 ounce, etc. on the blank. Next, the paperboard is fed to an inline poly-laminator 74 which laminates, i.e. applies a thin coat of plastic on the interior surface 32 of the cup 20 in order to waterproof the cup 20. After the cup 20 is plastic coated, it moves to the next station 78 in the web machine 70, which handles die cutting, embossing and die striping. In the station 78, a rotary die cuts the paperboard into a “flat” or blank. The dimensions of the flat vary according to the cup size. In order to create the measurement markings, the flats are then disposed on a pneumatic press and scored and embossed from the outside to the inside and are positioned with the optional interior color markings, mentioned above.

The blanks are stacked and transported to the forming machine 72 by way of a conveyor belt, indicated by the arrow 80. The flats are relayed to station 82 in the forming machine 72 which includes a carousel where mechanical jaws wrap each flat around a mandrel to form the flat into the shape of a cup. An FDA compliant adhesive and heat guns are used to seal opposing ends of the flat to form a vertical seam in the cup forming a cup body with a continuous sidewall.

With reference to FIG. 4A, a sectional view of the cup 20 on the mandrel, generally identified with the reference numeral 86, is illustrated. As shown, the mandrel 86 includes grooves 88 that correspond to the recessed measurement markings 30 on the flat. As shown best in FIG. 2A, raised markings are formed on the interior surface 32 and recesses are formed on the exterior surface 42 of the cup 20. At station 84 of the forming machine 72, a thin strip of industry standard plastic covered paper is fed into the machine 72. A dye punches circular shapes from the strip of paper forming the bottom of a cup. 20. The bottoms are shoved into the cup 20 as it sits on the mandrel 86. The bottom is heat sealed onto the cup 20 by melting the plastic backing on one side of the paper. The top of the cup is formed by rolling the paper with a heat gun to form a rim forming a finished cup. The rim enables sips to be taken without spills.

The last step in the process is ejecting the finished cup 20 from the mandrel 86. In the case of the cup 20 with the measurement markings 30, simply removing the cup 20 from the mandrel 86 in an axial direction could cause the cup 20 to tear since the grooves 88 on the mandrel 86 are complimentary to the measurement markings 30 and are thus embedded therein. As such, the mandrel 86 may be formed as a collapsible mandrel. By forming the mandrel as a collapsible mandrel, the mandrel 86 can be slightly collapsed to disengage the grooves 88 in the mandrel 86 from the recessed measurement markings 30 in the cup 20. The cup 20 is then safely ejected from the machine 72.

Collapsible mandrels are known in the art. An exemplary collapsible mandrel is described in detail in U.S. Pat. No. 4,233,020, hereby incorporated by reference.

FIGS. 3B and 4B illustrate the process for making the cup 50 with the stepped measurement markings 52. Referring first to FIG. 4B, the cup 50 is shown on a mandrel 87. The mandrel 87 may be a standard conical mandrel that is ground, for example, with a grinder, to form corresponding steps, generally indicated by the reference numeral 91, on the surface of the mandrel 87 that are complimentary to the measurement markings 52. In this case, the stepped grooves 91 are shallowly embedded in the stepped recesses 52 to allow the cup 50 to be removed from the mandrel 87 without collapsing or reducing the diameter and without tearing the cup 50.

The cup 50 may be made by the processes illustrated in FIGS. 3B and 5 by way of the web machine 89 and the forming machine 96 (FIG. 3B), which are similar to the web machine 70 and forming machine 72, illustrated in FIG. 3A. With the exception of the step of removing the finished cup 50 from the stepped mandrel 87, all of the process steps 90-100, illustrated in FIG. 3B are identical to the process steps 76-84, illustrated in FIG. 3A.

FIGS. 3C and 4C illustrate the process for making the cup 62 with the interior measurement markings 61. Referring first to FIG. 4C, the cup 62 is shown on a standard conical mandrel 101. With the exception of the step of removing the finished cup 62 from the stepped mandrel 101, all of the process steps 106-114, illustrated in FIG. 3C are virtually identical to the process steps 76-84, illustrated in FIG. 3A except the measurement markings are embossed or scored. As mentioned above, in this embodiment, measurement markings 61 may simply be printed on the interior surface of the cup 63, as best shown in FIG. 2c. Optional measurement markings may be printed on the exterior surface 65 (FIG. 1C) which correspond to the measurement markings on the interior surface 63.

Obviously, many modifications and variations of the present invention are possible in light of the above teachings. For example, the raised measurement markings can be formed on an exterior surface of the cup and the recessed measurement markings can be formed on an interior surface of the cup. Thus, it is to be understood that, within the scope of the appended claims, the invention may be practiced otherwise than as specifically described above.

What is claimed and desired to be secured by a Letters Patent of the United States is:

I claim:

1. A paper cup comprising:
a cup body formed as a continuous sidewall; and
a cup bottom for closing the bottom of the cup body, wherein measurement markings are formed on an inside surface of the cup body.

2. The paper cup as recited in claim 1, wherein corresponding measurement markings are formed on an exterior surface of the cup.

3. The paper cup as recited in claim 2, wherein the measurement markings on the interior surface and the exterior surface of the cup are printed.

4. The paper cup as recited in claim 2, wherein the measurement markings on the interior surface of the cup are raised relative to the interior surface of the cup.

5. The paper cup as recited in claim 4, wherein the measurement markings on the exterior surface of the cup are recessed relative to the exterior surface of the cup.

6. The paper cup as recited in claim 4, wherein the raised measurement markings on the interior surface of the cup are printed with one or more colors.

7. The paper cup as recited in claim 2, wherein the measurement markings on the exterior surface of the cup are raised relative to the exterior surface of the cup.

8. The paper cup as recited in claim 7, wherein the measurement markings on the interior surface of the cup are recessed relative to the interior surface of the cup.

9. The paper cup as recited in claim 4, wherein the measurement markings on the interior surface of the cup are formed with a generally semi-circular cross-section.

10. The paper cup as recited in claim 4, wherein the measurement markings on the interior surface of the cup are formed with a stepped cross-section.

11. The paper cup as recited in claim 2, wherein the measurement markings extend along the interior perimeter of the cup.

12. The paper cup as recited in claim 2, wherein the measurement markings are formed as short line segments.

13. A method for making a paper cup comprising the steps of:
(a) forming the flats for the paper cups by way of a forming machine with the following steps:
(i) unrolling a roll of paperboard;
(ii) print a desired pattern on the paperboard;
(iii) score measurement markings at desired measurement points;
(iv) laminate an interior surface of the cup
(v) cut the paperboard into a flat;
(b) transport the blanks to a forming machine wherein the forming machine performs the following steps:
(i) wrap the blanks around a grooved mandrel forming measurement markings on an exterior and interior surface of the blank thus forming the raised measurement markings on the interior surface and the recessed markings on the exterior surface of the cup;
(ii) seal opposing ends of the blank to form a cup body;
(iii) form a bottom;
(iv) seal the bottom to the cup body;
(v) roll the top of cup to form a rim; and
(vi) collapse the mandrel to remove the cup from the mandrel.

14. A method for making a paper cup comprising the steps of:
(a) forming the flats for the paper cups by way of a forming machine with the following steps:
(i) unrolling a roll of paperboard;
(ii) print a desired pattern on the paperboard;
(iii) score measurement markings at desired measurement points;
(iv) laminate an interior surface of the cup
(v) cut the paperboard into a flat;
(b) transport the blanks to a forming machine wherein the forming machine performs the following steps:
(i) wrap the blanks around a stepped mandrel forming measurement markings on an exterior and interior surface of the blank thus forming the raised measurement markings on the interior surface and the recessed markings on the exterior surface of the cup;
(ii) seal opposing ends of the blank to form a cup body;
(iii) form a bottom;
(iv) seal the bottom to the cup body;
(v) roll the top of cup to form a rim; and
(vi) remove the cup from the machine
